(19) United States
(12) Patent Application Publication
(10) Pub. No.: US 2011/0271668 A1
(43) Pub. Date: Nov. 10, 2011

(54) Torque Converter

(76) Inventors: Scott R. Dalenberg, Springfield, MO (US); Robert Steinmetz, Cranberry Township, PA (US); Jack W. Creighton, Hickory, PA (US)

(21) Appl. No.: 13/049,751

(22) Filed: Mar. 16, 2011

Related U.S. Application Data
(60) Provisional application No. 61/314,657, filed on Mar. 17, 2010.

(51) Int. Cl. F16H 41/24; B23P 11/00

(52) U.S. Cl. 60/330; 29/401.1

(57) ABSTRACT

The present invention relates to torque converters. In particular, the instant invention provides improved torque converters having an increase in capacity and an increase in efficiency.

### BACKGROUND OF THE INVENTION

1. Field of the Invention

The present invention relates to torque converters. In particular, the instant invention relates to improved torque converters having an increase in capacity and an increase in efficiency.

2. Description of Related Art

Currently, automatics are the transmissions of choice in today's consumer diesel applications. As such, torque converters are a factor in the reliability and durability of the diesel trucks. Typical consumer diesel applications offer more than 600 lb-ft of torque, thus, torque converters must be robust.

A torque converter may best be described as a fluid coupler. Because there is no conventional clutch on an automatic transmission, there must be some way to let the engine slip so the vehicle doesn't stop running if the vehicle slows to a stop. This is accomplished through a torque converter, which is a device that uses transmission fluid and a turbine-fan arrangement to create enough force to propel the vehicle yet slip enough to let the engine idle while in gear.

The functional nature of a torque converter allows (i) the vehicle to come to a stop allowing the engine to idle and the transmission to be in either forward or reverse mode without any interference of torque transfer to the wheels (the depression of the accelerator is the only action that needs to take place in order to again resume the forward or rearward motion of the vehicle); and (ii) the transmission to change ratios (gear ranges) without the sharp jolt that would result if such a hydraulic coupling did not exist. The modern torque converter adds one more element to this drive system—as the vehicle speed increases and the multiplication of the engine torque becomes less essential to the smooth movement of the vehicle, the converter has an internal clutch assembly that when applied by oil pressure from the transmission, couples the converter into a one to one mode (in this way, the torque converter clutch has removed all internal slip and has increased the efficiency of the drive train to that of a direct coupling).

This invention is the direct result of problems that have originated in the field. The original design resulted in clutch related failure as a result of normal truck use, therefore in order to better serve consumers, a more robust design was needed which performed in a similar manner yet demonstrated greater durability. The specific nature of the failure described rendered the original torque converter core unusable without major work that would often result is poor performance. Customer satisfaction required a new converter to be created. This invention meets that customer need.

The converter of the present application is totally interchangeable with the original design converters, thus improving the efficiency of the vehicle without requiring any additional work or alteration on the part of the consumer. At present, there are no other torque converters on the market today that can satisfy all the deficiencies that exist within the original design, nor do the components available to remanufacture the original converter design solve the problems which result in a fifty percent (50%) increase in capacity and ten percent (10%) increase in efficiency.

### SUMMARY OF THE INVENTION

The instant invention contemplates an improved torque converter.

The instant invention also contemplates improved torque converters having an increase in capacity and an increase in efficiency.

The instant invention also contemplates improved torque converters having a fifty percent (50%) increase in capacity and ten percent (10%) increase in efficiency.

One embodiment, of the present invention contemplates a torque converter having a one piece billet cover that incorporates a thick steel ring three hundred and sixty degrees about the cover into which the flywheel is bolted.

Another embodiment of the present invention contemplates a torque converter having one continual ring that evenly transfers the engine torque into the torque converter without clutch surface distortion.

The present invention further contemplates torque converters that provide improved efficiency through the multiplication stages of torque transfer (first and second gear) and add the multiplication effect to the lock up stage (third and fourth gear).

These and other aspects, objects, features and advantages of the present invention will be more clearly understood and appreciated from a review of the following detailed description of the invention.

### BRIEF DESCRIPTION OF THE FIGURES

FIG. 1 provides a schematic of one embodiment of the present invention.

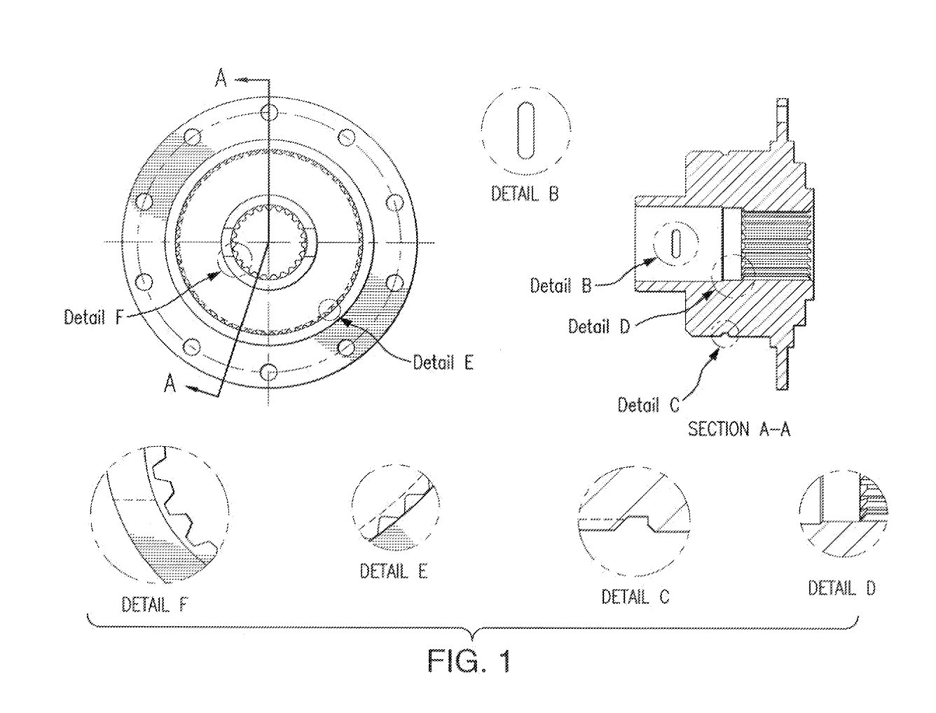

FIG. 2 provides a schematic of an embodiment of the present invention.

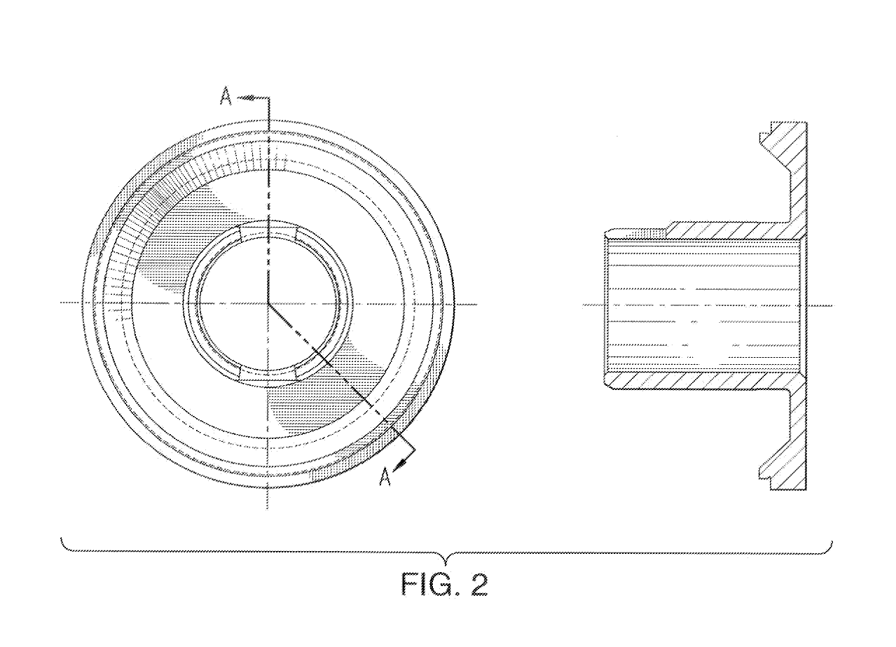

FIG. 3 provides a schematic of an embodiment of the present invention.

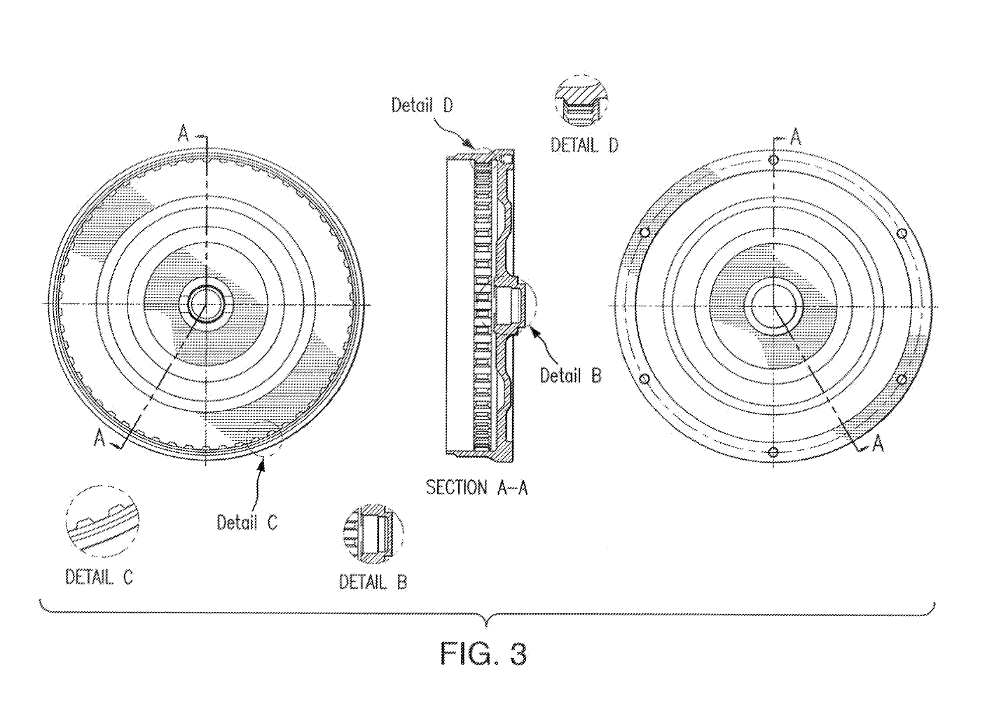

FIG. 4 provides a graphical representation of the results of testing one embodiment of the present invention.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implicated in other compositions and methods, and that any such variation would be within such modifications that do not part from the scope of the present invention. Before explaining the disclosed embodiments of the present invention in detail, it is to be understood that the invention is not limited in its application to the details of any particular embodiment shown, since of course the invention is capable of other embodiments. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

The functional nature of a torque converter allows (i) the vehicle to come to a stop allowing the engine to idle and the transmission to be in either forward or reverse mode without any interference of torque transfer to the wheels (the depression of the accelerator is the only action that needs to take place in order to again resume the forward or rearward motion of the vehicle); and (ii) the transmission to change ratios (gear ranges) without the sharp jolt that would result if such a hydraulic coupling did not exist. The modern torque converter adds one more element to this drive system—as the vehicle speed increases and the multiplication of the engine torque becomes less essential to the smooth movement of the vehicle, the converter has an internal clutch assembly that when applied by oil pressure from the transmission, couples the converter into a one to one mode (in this way, the torque converter clutch has removed all internal slip and has increased the efficiency of the drive train to that of a direct coupling).

The present invention contemplates a novel torque converter. Torque converters constructed in accordance with the present invention may be used a direct replacement to the Chrysler 618/48RE factory converter when used in combination with a 5.9 L Cummins Diesel Engine.

One of ordinary skill in the are will recognized that the present torque converter may also be used in other applications.

Torque converters in accordance with the present invention do not require any alteration on the part of the end user and are engineered and designed with a compatible impeller hub, compatible stator drive, compatible input spline drive, and cover geometry that directly bolt to the existing crankshaft centering members and drive plate systems that typically exist on current vehicles. Certain embodiments of the present invention are particularly adapted to Chrysler vehicles. All of the components used in the present invention specify and uniquely created by Recon or purchased from an outside vender for this sole purpose. This new torque converter has a similar outward appearance to that of the original converter, in that the impeller huh and cover have similar geometry which allows for the complete interchangeability, however if the two converters were placed side by side the difference would become very obvious to one trained in the art.

This new design torque converter increases the durability of the converter within this drive train by eliminating the cover distortion that currently occurs within the factory design and increases the converter clutch life and apply effectiveness. The current factory design incorporates six pads that are welded to the cover shell. The presently described converter uses a one piece billet cover that incorporates a thick steel ring three hundred and sixty degrees about the cover into which the flywheel is bolted.

The original manufacture design requires that the torque of the engine be transferred to the torque converter through these six points of attachment. The original design pads (points of attachment) deflect under the torque load in the opposite direction and in so doing deflect the lock up clutch surface that is located opposite of the welded pad inside the torque converter. When this clutch surface deflection occurs the lock up clutch is lifted off the smooth flat lock up surface and requires the lock up piston to maintain its apply on the resulting six high spots which are the result of the pad deflection. This phenomena produces three very undesirable affects, first the clutch is no longer in contact with the friction apply surface three hundred and sixty degrees, second a rather large oil leak is created between the high point of each pad deflection and the lock up piston, and third the converter begins to slip on the six high points of deflection and multiply torque without the associated cooling circuit.

The new design eliminates the deflection created by the engine torque entering the converter by the use of one continual ring that evenly transfers the engine torque into the torque converter without clutch surface distortion. This system allows the lock up piston to maintain a three hundred sixty degree contact constantly regardless of the level of torque transfer. This new design further enhances the lock up system of the drive train by incorporating three friction rings within the lock up mechanism instead of the factory designed one. In so doing the clutch bearing capacity is constantly no less than that required by the original design and is increased at least fifty percent (50%) over that same original design.

This new torque converter will provide improved efficiency through the multiplication stages of torque transfer (first and second gear) and add the multiplication effect to the lock up stage (third and fourth gear) that the current original equipment converter lacks. The added efficiency of this new design torque converter results in a reduction in the fuel consumption rate which has the added feature of creating less overall heat due to slippage. The reduction in heat reduces the amount of BTUs that must be extracted from the oil by the system heat exchanger and in so doing extends the life to the drive train. One of the primary problems that results from use of a torque converter in a drive system is the detrimental affect high temperatures have on the oil used to lubricate and cool the transmission and the neoprene seals that are used to contain this same oil within the different shifting and ratio generating elements of the transmission. This new designed torque converter lowers the amount of heat generated by ten percent (10%) when used in conjunction with an engine that is producing four to five hundred foot pounds of torque (Factory settings).

The present invention may be used as a direct replacement torque converter in an original Chrysler manufactured truck. In particular, the presently described torque converter may be used in conjunction with an unaltered or non-enhanced Cummins 5.9 L diesel engine and a 48RE Chrysler transmission.

### Example 1

The first prototype design was created and tested in a truck of known standard Chrysler configuration. The prototype torque converter was installed in the truck and the owner was requested to subject the truck to all the typical and/or normal conditions and requirements to which the truck was expected to perform; this test included load testing, acceleration testing, and durability testing. This destructive test lasted seven days.

Upon completion of this destructive test, the torque converter was removed from the test truck and disassembled for examination and part performance evaluation. None of the parts demonstrated any evidence of failure.

Torque'converters in accordance with the present invention can be made by the following steps:

1. Create a custom impeller hub.
2. Weld custom impeller hub into 95K impeller pump to specific height specifications.
3. Have custom stator machined/created.
4. Have custom stator caps machined/created.
5. Have custom stator inner spline race machined/created.
6. Assemble custom stator into assembly using new internal springs and rollers.
7. Weld all fins both internal and external on a compatible turbine.
8. Create a custom turbine hub.
9. Machine the internal bore of the turbine to the custom turbine shoulder on the custom turbine hub.
10. Drill new rivet pattern in the turbine to match the custom pattern of rivet holes created in the custom turbine hub.
11. Rivet the custom turbine and the custom turbine hub together.
12. Weld the custom turbine hub to the custom turbine.
13. Create a custom cover.
14. Assemble the custom impeller, the custom stator, the custom turbine, the multi friction, damper assembly, and the custom cover into a complete converter assembly.
15. Weld custom torque converter assembly together.
16. Subject custom torque converter assembly to all external and internal alignment requirements.
17. Custom torque converter is completed.

### Example 2

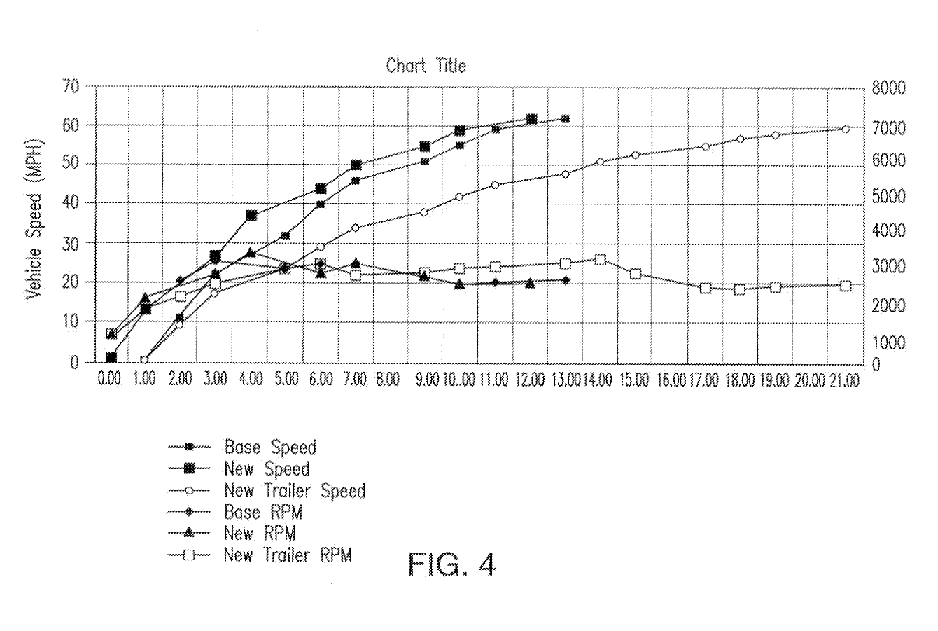

Embodiments of the present invention were tested an found to have greater performance and durability that the standard torque converter. The results of the testing a shown in Tables 1-2 and FIGS. 4 & 5.

TABLE 1
baseline test results

| | Throttle Position | Vehicle Speed | Engine Speed |
|---|---|---|---|
| Time | Angle (%) | (MPH) | (RPM) |
| 0 | 10.2 | 39 | 1607 |
| 1.52 | 9 | 39 | 1533 |
| 3.05 | 12.5 | 38 | 1612 |
| 4.56 | 14.1 | 37 | 1583 |
| 6.08 | 14.9 | 37 | 1594 |
| 7.59 | 15.7 | 37 | 1600 |
| 9.11 | 16.5 | 37 | 1617 |
| 10.63 | 14.9 | 38 | 1645 |
| 12.14 | 13.7 | 38 | 1573 |
| 13.66 | 12.2 | 38 | 1578 |
| 15.17 | 11.8 | 38 | 1569 |
| 16.69 | 11.8 | 38 | 1565 |
| 18.2 | 11 | 39 | 1606 |
| 19.72 | 12.2 | 39 | 1604 |
| 21.24 | 13.7 | 39 | 1599 |
| 22.75 | 14.5 | 39 | 1615 |
| 24.27 | 14.1 | 39 | 1629 |
| 25.78 | 14.1 | 39 | 1633 |
| 27.31 | 14.9 | 38 | 1620 |
| 28.83 | 12.5 | 39 | 1616 |
| 30.34 | 13.3 | 39 | 1591 |
| 31.86 | 14.5 | 40 | 1651 |
| 33.38 | 11.8 | 40 | 1648 |
| 34.89 | 14.1 | 40 | 1660 |
| 36.41 | 15.3 | 40 | 1673 |
| 37.94 | 17.6 | 40 | 1700 |
| 39.45 | 16.9 | 40 | 1736 |
| 40.97 | 17.3 | 41 | 1727 |
| 42.49 | 17.3 | 42 | 1768 |
| 44 | 17.6 | 43 | 1804 |
| 45.53 | 17.6 | 44 | 1833 |
| 47.05 | 16.5 | 43 | 1821 |
| 48.55 | 13.7 | 43 | 1794 |
| 50.09 | 14.5 | 42 | 1713 |
| 51.61 | 16.5 | 41 | 1577 |
| 53.11 | 16.9 | 41 | 1521 |
| 54.63 | 15.7 | 42 | 1561 |
| 56.14 | 15.7 | 43 | 1542 |
| 57.66 | 13.7 | 43 | 1460 |
| 59.17 | 14.9 | 45 | 1510 |
| 60.69 | 15.3 | 45 | 1512 |
| 62.2 | 13.7 | 46 | 1499 |
| 63.72 | 14.1 | 47 | 1470 |
| 65.25 | 14.1 | 47 | 1479 |
| 66.77 | 14.5 | 47 | 1250 |
| 68.28 | 14.1 | 47 | 1259 |
| 69.81 | 13.3 | 48 | 1272 |
| 71.31 | 12.5 | 48 | 1264 |
| 72.84 | 3.9 | 47 | 1265 |
| 74.36 | 3.9 | 45 | 1228 |
| 75.88 | 4.3 | 43 | 1173 |
| 77.39 | 7.8 | 41 | 1203 |
| 78.91 | 6.7 | 39 | 1121 |
| 80.42 | 0 | 36 | 961 |
| 81.95 | 0.8 | 35 | 910 |
| 83.47 | 15.7 | 34 | 1078 |
| 84.97 | 43.9 | 36 | 1844 |
| 86.49 | 54.9 | 39 | 2081 |
| 88 | 31.4 | 42 | 2092 |
| 89.52 | 28.2 | 43 | 1924 |
| 91.05 | 9 | 42 | 1795 |
| 92.56 | 5.9 | 39 | 1502 |
| 94.08 | 9.4 | 37 | 1163 |
| 95.59 | 9.4 | 37 | 1208 |
| 97.13 | 10.6 | 37 | 1268 |
| 98.64 | 8.6 | 37 | 1237 |
| 100.14 | 3.9 | 37 | 1218 |
| 101.67 | 2.7 | 36 | 1057 |
| 103.17 | 1.2 | 35 | 955 |
| 104.69 | 2 | 35 | 1023 |
| 106.2 | 0 | 34 | 900 |
| 107.72 | 0 | 33 | 926 |
| 109.25 | 0 | 32 | 912 |
| 110.77 | 2.7 | 32 | 946 |
| 112.28 | 0 | 32 | 959 |
| 113.8 | 0 | 31 | 886 |
| 115.31 | 1.2 | 30 | 871 |
| 116.83 | 7.1 | 29 | 1084 |
| 118.34 | 14.9 | 32 | 1248 |
| 119.86 | 19.2 | 35 | 1624 |
| 121.38 | 25.1 | 37 | 1756 |
| 122.89 | 28.2 | 39 | 1831 |
| 124.41 | 25.9 | 40 | 1879 |
| 125.92 | 23.9 | 42 | 1856 |
| 127.44 | 20.4 | 43 | 1828 |
| 128.97 | 20 | 43 | 1829 |
| 130.49 | 20 | 43 | 1823 |
| 132 | 20 | 42 | 1820 |
| 133.53 | 17.6 | 40 | 1779 |
| 135.05 | 11 | 38 | 1621 |
| 136.55 | 0 | 35 | 1289 |
| 138.06 | 0 | 32 | 959 |
| 139.58 | 4.3 | 30 | 955 |
| 141.09 | 14.5 | 30 | 1286 |
| 142.61 | 20.4 | 32 | 1636 |
| 144.13 | 17.3 | 34 | 1711 |
| 145.64 | 12.5 | 35 | 1560 |
| 147.16 | 8.6 | 35 | 1464 |
| 148.67 | 7.5 | 34 | 1404 |
| 150.17 | 7.1 | 33 | 1350 |
| 151.7 | 6.7 | 32 | 1332 |
| 153.22 | 7.5 | 32 | 1384 |
| 154.74 | 1.2 | 32 | 1273 |
| 156.27 | 0 | 30 | 939 |
| 157.77 | 0 | 27 | 948 |
| 159.28 | 0 | 23 | 908 |
| 160.8 | 0 | 19 | 888 |
| 162.31 | 0 | 16 | 797 |
| 163.83 | 0 | 11 | 797 |
| 165.36 | 0 | 7 | 849 |
| 166.88 | 0 | 4 | 797 |
| 168.38 | 0 | 0 | 797 |
| 169.91 | 0 | 0 | 800 |
| 171.42 | 0 | 0 | 800 |
| 172.94 | 19.2 | 1 | 1272 |
| 174.45 | 20.4 | 14 | 1617 |
| 175.97 | 23.5 | 19 | 1852 |
| 177.5 | 25.9 | 25 | 1773 |
| 179.02 | 28.6 | 29 | 1872 |
| 180.55 | 29.8 | 32 | 1934 |
| 182.06 | 29 | 34 | 2034 |
| 183.58 | 25.9 | 35 | 2103 |
| 185.08 | 25.9 | 36 | 2145 |
| 186.61 | 25.5 | 37 | 2171 |
| 188.13 | 23.9 | 38 | 2207 |
| 189.64 | 22 | 39 | 2242 |
| 191.16 | 6.7 | 39 | 2255 |
| 192.67 | 0 | 36 | 1703 |
| 194.19 | 0 | 34 | 1543 |
| 195.7 | 0 | 32 | 1401 |
| 197.22 | 0 | 29 | 1258 |
| 198.74 | 7.8 | 27 | 1121 |
| 200.25 | 19.2 | 28 | 1687 |
| 201.78 | 20.4 | 30 | 1824 |
| 203.3 | 20.4 | 32 | 1931 |
| 204.81 | 21.6 | 34 | 2012 |
| 206.33 | 20.4 | 35 | 2079 |
| 207.84 | 19.6 | 37 | 2130 |
| 209.36 | 20 | 37 | 2167 |
| 210.88 | 18.4 | 37 | 2186 |
| 212.39 | 0 | 35 | 1677 |
| 213.91 | 0 | 34 | 1529 |
| 215.42 | 0 | 31 | 1391 |
| 216.94 | 6.7 | 29 | 1251 |
| 218.45 | 18.4 | 29 | 1774 |
| 219.97 | 22.7 | 31 | 1863 |
| 221.5 | 20.4 | 33 | 1960 |
| 223.02 | 15.7 | 35 | 2023 |
| 224.53 | 12.2 | 35 | 1474 |
| 226.05 | 11.8 | 36 | 1494 |
| 227.56 | 9.4 | 36 | 1489 |
| 229.08 | 9 | 37 | 1476 |
| 230.59 | 9.4 | 37 | 1484 |
| 232.11 | 9.4 | 37 | 1485 |
| 233.63 | 9 | 37 | 1470 |
| 235.16 | 8.6 | 36 | 1457 |
| 236.67 | 8.6 | 35 | 1434 |
| 238.2 | 9.4 | 35 | 1431 |
| 239.72 | 9 | 35 | 1436 |
| 241.24 | 9 | 35 | 1426 |
| 242.75 | 8.6 | 35 | 1421 |
| 244.27 | 6.7 | 34 | 1383 |
| 245.78 | 7.5 | 34 | 1379 |
| 247.3 | 5.9 | 34 | 1378 |
| 248.81 | 2.4 | 32 | 1220 |
| 250.33 | 3.1 | 32 | 1105 |
| 251.83 | 2.7 | 30 | 1184 |
| 253.36 | 3.9 | 30 | 1211 |
| 254.88 | 1.2 | 29 | 1198 |
| 256.38 | 0 | 29 | 948 |
| 257.91 | 0 | 27 | 953 |
| 259.42 | 0 | 25 | 918 |
| 260.94 | 0 | 23 | 881 |
| 262.45 | 0 | 21 | 899 |
| 263.97 | 0 | 19 | 831 |
| 265.5 | 0 | 18 | 817 |
| 267.02 | 0 | 18 | 808 |
| 268.53 | 0 | 16 | 796 |
| 270.05 | 0 | 12 | 796 |
| 271.56 | 0 | 7 | 795 |
| 273.08 | 0 | 5 | 794 |
| 274.59 | 0 | 0 | 799 |
| 276.11 | 0 | 0 | 800 |
| 277.63 | 0 | 0 | 803 |
| 279.14 | 0 | 0 | 799 |
| 280.66 | 0 | 0 | 802 |
| 282.17 | 0 | 0 | 798 |
| 283.69 | 0 | 0 | 801 |
| 285.22 | 0 | 0 | 800 |
| 286.74 | 0 | 0 | 802 |
| 288.25 | 0 | 0 | 800 |
| 289.78 | 0 | 0 | 800 |
| 291.28 | 0 | 0 | 801 |
| 292.81 | 0 | 0 | 800 |
| 294.33 | 0 | 0 | 801 |
| 295.84 | 0 | 0 | 799 |
| 297.36 | 5.9 | 1 | 814 |
| 299.84 | 11.8 | 9 | 1203 |
| 301.36 | 11.8 | 13 | 1377 |
| 302.89 | 5.9 | 14 | 1425 |
| 304.41 | 0 | 14 | 865 |
| 305.91 | 0 | 11 | 803 |
| 307.42 | 9.8 | 10 | 826 |
| 308.94 | 14.9 | 11 | 1333 |
| 310.45 | 20 | 14 | 1604 |
| 311.99 | 23.1 | 18 | 1778 |
| 313.5 | 26.3 | 22 | 1741 |
| 315.02 | 25.9 | 25 | 1815 |
| 316.53 | 28.2 | 27 | 1863 |
| 318.06 | 24.7 | 29 | 1767 |
| 319.58 | 23.5 | 32 | 1751 |
| 321.08 | 20.4 | 33 | 1748 |
| 322.61 | 19.6 | 35 | 1733 |
| 324.13 | 17.6 | 35 | 1685 |
| 325.64 | 19.2 | 35 | 1629 |
| 327.16 | 22 | 35 | 1737 |
| 328.69 | 21.6 | 34 | 1751 |
| 330.2 | 22 | 34 | 1751 |
| 331.72 | 21.2 | 34 | 1748 |
| 333.24 | 20.4 | 33 | 1724 |
| 334.77 | 18.4 | 33 | 1692 |
| 336.28 | 16.5 | 33 | 1623 |
| 337.78 | 15.3 | 34 | 1594 |
| 339.31 | 13.7 | 35 | 1520 |
| 340.83 | 12.9 | 35 | 1489 |
| 342.34 | 12.2 | 35 | 1512 |
| 343.86 | 11.8 | 35 | 1477 |
| 345.39 | 12.5 | 35 | 1468 |
| 346.91 | 12.9 | 35 | 1483 |
| 348.42 | 13.7 | 35 | 1505 |
| 349.94 | 13.7 | 35 | 1508 |
| 351.45 | 13.3 | 35 | 1490 |
| 352.97 | 13.3 | 35 | 1498 |
| 354.49 | 12.5 | 35 | 1497 |
| 356.02 | 12.2 | 35 | 1501 |
| 357.53 | 12.9 | 36 | 1505 |
| 359.05 | 12.9 | 36 | 1513 |
| 360.56 | 12.5 | 36 | 1530 |
| 362.09 | 8.6 | 35 | 1456 |
| 363.61 | 0 | 33 | 1176 |
| 365.13 | 0 | 30 | 958 |
| 366.64 | 0 | 27 | 941 |
| 368.16 | 0 | 24 | 906 |
| 369.67 | 4.7 | 21 | 881 |
| 371.19 | 14.1 | 21 | 1069 |
| 372.72 | 19.2 | 24 | 1508 |
| 374.22 | 23.1 | 27 | 1663 |
| 375.74 | 22.7 | 30 | 1717 |
| 377.25 | 22.4 | 32 | 1739 |
| 378.77 | 20.4 | 35 | 1735 |
| 380.3 | 20.4 | 37 | 1742 |
| 381.81 | 21.2 | 38 | 1758 |
| 383.33 | 21.6 | 40 | 1775 |
| 384.84 | 21.2 | 41 | 1782 |
| 386.38 | 19.6 | 43 | 1822 |
| 387.89 | 20 | 44 | 1841 |
| 389.39 | 19.2 | 45 | 1870 |
| 390.92 | 17.6 | 46 | 1881 |
| 392.44 | 16.9 | 48 | 1845 |
| 393.95 | 16.9 | 50 | 1899 |
| 395.47 | 15.7 | 50 | 1329 |
| 397 | 13.7 | 50 | 1338 |
| 398.52 | 10.2 | 48 | 1303 |
| 400.03 | 6.7 | 45 | 1233 |
| 401.55 | 11 | 42 | 1272 |
| 403.05 | 12.2 | 42 | 1371 |
| 404.58 | 11 | 42 | 1339 |
| 406.09 | 10.2 | 42 | 1314 |
| 407.59 | 0 | 39 | 1152 |
| 409.13 | 0 | 35 | 925 |
| 410.64 | 0 | 30 | 911 |
| 412.16 | 0 | 24 | 816 |
| 413.67 | 0 | 19 | 795 |
| 415.19 | 0 | 14 | 796 |
| 416.69 | 0 | 7 | 801 |
| 418.2 | 10.2 | 5 | 796 |
| 419.74 | 17.3 | 8 | 1523 |
| 421.25 | 15.3 | 14 | 1622 |
| 422.75 | 15.7 | 17 | 1738 |
| 424.27 | 13.3 | 20 | 1429 |
| 425.78 | 0 | 21 | 1025 |
| 427.31 | 0 | 16 | 800 |
| 428.81 | 0 | 11 | 795 |
| 430.33 | 0 | 7 | 798 |
| 431.84 | 0 | 0 | 793 |
| 433.36 | 0 | 0 | 802 |
| 434.89 | 91 | 4 | 1605 |
| 436.41 | 92.5 | 19 | 2052 |
| 437.92 | 91 | 30 | 2715 |
| 439.44 | 92.9 | 37 | 2483 |
| 440.95 | 100 | 43 | 2567 |
| 442.47 | 100 | 48 | 2787 |
| 443.99 | 100 | 53 | 2560 |
| 445.5 | 100 | 58 | 2520 |
| 447.02 | 91.4 | 62 | 2325 |
| 448.53 | 15.7 | 60 | 2221 |
| 450.05 | 11.8 | 58 | 1956 |
| 451.56 | 5.9 | 56 | 1530 |
| 453.08 | 19.6 | 55 | 1476 |
| 454.61 | 22.4 | 57 | 1486 |
| 456.13 | 22.4 | 57 | 1512 |
| 457.64 | 15.3 | 57 | 1528 |
| 459.14 | 14.1 | 56 | 1514 |
| 460.66 | 13.3 | 54 | 1462 |
| 462.17 | 13.7 | 55 | 1429 |
| 463.69 | 12.9 | 55 | 1469 |
| 465.22 | 11 | 55 | 1472 |
| 466.74 | 12.9 | 55 | 1465 |
| 468.25 | 13.7 | 55 | 1462 |
| 469.77 | 13.3 | 54 | 1448 |
| 471.28 | 14.9 | 53 | 1435 |
| 472.8 | 15.3 | 52 | 1411 |
| 474.31 | 25.9 | 52 | 1390 |
| 475.84 | 22 | 52 | 1400 |
| 477.34 | 22.4 | 53 | 1400 |
| 478.86 | 18.4 | 53 | 1420 |
| 480.38 | 15.3 | 54 | 1432 |
| 481.89 | 14.5 | 54 | 1436 |
| 483.42 | 14.1 | 53 | 1428 |
| 484.94 | 13.7 | 53 | 1412 |
| 486.45 | 16.5 | 52 | 1397 |
| 487.97 | 16.5 | 52 | 1383 |
| 489.47 | 17.6 | 52 | 1377 |
| 491 | 17.6 | 52 | 1387 |
| 492.52 | 16.5 | 53 | 1402 |
| 494.02 | 14.1 | 52 | 1397 |
| 495.55 | 12.5 | 51 | 1382 |
| 497.06 | 14.5 | 50 | 1345 |
| 498.58 | 13.7 | 51 | 1346 |
| 500.09 | 12.9 | 53 | 1385 |
| 501.61 | 12.9 | 55 | 1436 |
| 503.13 | 12.9 | 55 | 1460 |
| 504.64 | 14.1 | 54 | 1453 |
| 506.16 | 14.5 | 53 | 1429 |
| 507.67 | 14.1 | 52 | 1391 |
| 509.19 | 17.3 | 52 | 1367 |
| 510.72 | 15.7 | 53 | 1393 |
| 512.24 | 13.7 | 55 | 1437 |
| 513.75 | 13.7 | 56 | 1460 |
| 515.27 | 13.7 | 56 | 1486 |
| 516.78 | 16.5 | 55 | 1467 |
| 518.3 | 16.5 | 53 | 1436 |
| 519.81 | 18.4 | 52 | 1396 |
| 521.33 | 0 | 49 | 1345 |
| 522.84 | 0 | 46 | 956 |
| 524.34 | 0 | 42 | 935 |
| 525.88 | 18.4 | 42 | 1543 |
| 527.39 | 19.2 | 43 | 1648 |
| 528.91 | 13.7 | 43 | 1610 |
| 530.44 | 0 | 42 | 1324 |
| 531.94 | 0 | 40 | 930 |
| 533.45 | 0 | 36 | 911 |
| 534.97 | 0 | 30 | 910 |
| 536.49 | 0 | 23 | 810 |
| 538.02 | 0 | 17 | 797 |
| 539.53 | 0 | 11 | 793 |
| 542 | 0 | 3 | 826 |
| 543.52 | 0 | 0 | 799 |
| 545.03 | 100 | 9 | 1644 |
| 546.55 | 100 | 22 | 2138 |
| 548.06 | 100 | 32 | 2883 |
| 549.58 | 100 | 40 | 2529 |
| 551.11 | 100 | 47 | 2703 |
| 552.63 | 100 | 52 | 2951 |
| 554.14 | 100 | 57 | 2508 |
| 555.66 | 100 | 61 | 2284 |
| 557.17 | 20.4 | 60 | 2318 |
| 558.69 | 12.2 | 59 | 2197 |
| 560.22 | 11.8 | 58 | 1620 |
| 561.74 | 15.7 | 58 | 1550 |
| 563.24 | 15.3 | 58 | 1542 |
| 564.75 | 15.7 | 57 | 1525 |
| 566.27 | 14.9 | 57 | 1498 |
| 567.78 | 11 | 58 | 1530 |
| 569.31 | 13.7 | 58 | 1556 |
| 570.83 | 14.9 | 58 | 1554 |
| 572.34 | 15.7 | 58 | 1531 |
| 573.86 | 15.3 | 57 | 1527 |
| 575.38 | 14.1 | 56 | 1507 |
| 576.89 | 15.7 | 55 | 1475 |
| 578.41 | 14.5 | 53 | 1430 |
| 579.91 | 9.8 | 50 | 1372 |
| 581.44 | 8.6 | 48 | 1309 |
| 582.95 | 6.7 | 48 | 1287 |
| 584.47 | 6.7 | 47 | 1263 |
| 585.99 | 0 | 45 | 1211 |
| 587.52 | 0 | 43 | 928 |
| 589.03 | 0 | 39 | 927 |
| 590.55 | 0 | 34 | 881 |
| 592.06 | 0 | 28 | 890 |
| 593.56 | 0 | 22 | 790 |
| 595.09 | 0 | 17 | 794 |
| 596.61 | 0 | 13 | 794 |
| 598.11 | 0 | 11 | 797 |
| 599.64 | 0 | 9 | 879 |
| 602.11 | 0 | 5 | 801 |
| 603.64 | 0 | 0 | 799 |
| 605.14 | 96.5 | 1 | 828 |
| 606.66 | 100 | 14 | 1873 |
| 608.17 | 100 | 27 | 2487 |
| 609.69 | 100 | 37 | 3172 |
| 611.2 | 100 | 44 | 2582 |
| 612.72 | 100 | 50 | 2867 |
| 614.24 | 100 | 55 | 2492 |
| 615.75 | 100 | 59 | 2286 |
| 617.27 | 69.4 | 62 | 2330 |
| 621.05 | 0 | 60 | 2292 |
| 622.55 | 0 | 58 | 1182 |
| 624.08 | 0 | 55 | 1118 |
| 625.59 | 0 | 50 | 985 |
| 627.11 | 0 | 45 | 938 |
| 628.64 | 0 | 40 | 937 |
| 630.14 | 0 | 35 | 879 |
| 631.66 | 0 | 30 | 897 |
| 633.17 | 0 | 25 | 808 |
| 634.69 | 0 | 19 | 797 |
| 636.22 | 0 | 14 | 802 |
| 638.69 | 0 | 0 | 797 |
| 640.2 | 0 | 0 | 797 |
| 641.72 | 0 | 0 | 800 |
| 643.24 | 0 | 0 | 798 |
| 644.74 | 0 | 0 | 803 |
| 646.25 | 0 | 0 | 803 |
| 648.74 | 15.3 | 9 | 1281 |
| 650.25 | 16.9 | 16 | 1520 |
| 651.78 | 15.3 | 19 | 1754 |
| 653.3 | 11.8 | 22 | 1480 |
| 654.81 | 8.2 | 23 | 1228 |
| 656.33 | 19.2 | 25 | 1110 |
| 657.86 | 16.5 | 27 | 1533 |
| 659.38 | 19.6 | 30 | 1557 |
| 660.88 | 18.4 | 32 | 1649 |
| 662.41 | 18.4 | 34 | 1674 |
| 663.91 | 23.1 | 37 | 1723 |
| 665.42 | 21.6 | 39 | 1771 |
| 666.94 | 20.4 | 42 | 1794 |
| 668.45 | 20 | 45 | 1684 |
| 669.99 | 15.3 | 47 | 1787 |
| 671.5 | 15.3 | 47 | 1832 |
| 673.02 | 16.5 | 49 | 1349 |
| 674.53 | 16.9 | 50 | 1327 |
| 676.03 | 16.9 | 52 | 1367 |
| 677.56 | 14.5 | 53 | 1403 |
| 679.08 | 0 | 54 | 1078 |
| 680.59 | 0 | 53 | 999 |
| 682.11 | 0 | 52 | 968 |
| 683.63 | 0 | 49 | 956 |
| 685.14 | 11.4 | 47 | 967 |
| 686.66 | 8.6 | 45 | 1226 |
| 688.17 | 6.7 | 42 | 1251 |
| 689.69 | 4.3 | 43 | 1225 |
| 691.2 | 0 | 45 | 1171 |
| 692.72 | 0 | 45 | 936 |
| 694.24 | 0 | 45 | 933 |
| 695.75 | 0 | 44 | 932 |
| 697.28 | 0 | 43 | 926 |
| 698.8 | 0 | 42 | 1008 |
| 700.3 | 0 | 41 | 1012 |
| 701.81 | 0 | 39 | 1010 |
| 703.33 | 0 | 34 | 978 |
| 704.84 | 0 | 29 | 901 |
| 706.38 | 0 | 22 | 790 |
| 707.89 | 0 | 16 | 795 |
| 709.41 | 0 | 9 | 797 |
| 710.91 | 0 | 7 | 817 |
| 713.39 | 0 | 5 | 797 |
| 714.92 | 0 | 0 | 795 |
| 716.44 | 0 | 0 | 850 |
| 717.94 | 0 | 0 | 854 |
| 719.47 | 0 | 0 | 853 |
| 720.99 | 0 | 0 | 854 |
| 722.5 | 0 | 0 | 853 |
| 724.02 | 0 | 0 | 858 |
| 725.53 | 0 | 0 | 856 |
| 727.06 | 0 | 0 | 856 |
| 728.58 | 0 | 0 | 855 |
| 730.09 | 0 | 0 | 849 |

TABLE 2
test results with torque converter in
accordance with the present invention

| | Throttle Position | Vehicle Speed | Engine Speed |
|---|---|---|---|
| | Angle (%) | (MPH) | (RPM) |
| 0 | 0 | 0 | 799 |
| 1.33 | 0 | 0 | 801 |
| 2.64 | 0 | 0 | 803 |
| 3.95 | 0 | 1 | 797 |
| 5.28 | 0 | 2 | 798 |
| 6.59 | 0 | 2 | 798 |
| 7.91 | 0 | 3 | 846 |
| 9.23 | 0 | 3 | 803 |
| 10.55 | 0 | 4 | 794 |
| 11.86 | 0 | 4 | 804 |
| 13.19 | 0 | 3 | 800 |
| 14.5 | 0 | 0 | 832 |
| 15.81 | 5.5 | 0 | 1176 |
| 18.11 | 11 | 11 | 1659 |
| 19.42 | 17.6 | 16 | 1695 |
| 20.73 | 20 | 20 | 1747 |
| 22.06 | 20.4 | 25 | 1709 |
| 23.37 | 21.2 | 30 | 1765 |
| 24.68 | 20.4 | 35 | 1818 |
| 26.01 | 21.2 | 38 | 1842 |
| 27.32 | 21.6 | 40 | 1873 |
| 28.63 | 23.1 | 40 | 1911 |
| 29.96 | 23.9 | 41 | 1934 |
| 31.27 | 26.7 | 43 | 1993 |
| 32.59 | 29.4 | 43 | 2054 |
| 33.91 | 31.4 | 45 | 2065 |
| 35.23 | 32.2 | 45 | 2068 |
| 36.54 | 32.9 | 44 | 2061 |
| 37.86 | 32.9 | 43 | 2053 |
| 39.18 | 31.4 | 43 | 2043 |
| 40.5 | 31 | 45 | 1855 |
| 41.82 | 29 | 49 | 1958 |
| 43.13 | 26.7 | 52 | 2016 |
| 44.46 | 28.2 | 53 | 2051 |
| 45.77 | 30.2 | 53 | 1441 |
| 47.08 | 30.2 | 55 | 1470 |
| 48.39 | 30.2 | 55 | 1463 |
| 49.7 | 26.7 | 55 | 1452 |
| 51.03 | 25.1 | 55 | 1473 |
| 52.34 | 22 | 55 | 1483 |
| 53.66 | 21.6 | 56 | 1493 |
| 54.98 | 21.6 | 57 | 1501 |
| 56.3 | 21.2 | 57 | 1499 |
| 57.61 | 21.6 | 56 | 1491 |
| 58.94 | 23.1 | 56 | 1490 |
| 60.25 | 21.6 | 56 | 1497 |
| 61.56 | 22 | 57 | 1513 |
| 62.89 | 19.6 | 57 | 1517 |
| 64.2 | 19.6 | 57 | 1524 |
| 65.51 | 17.6 | 57 | 1517 |
| 66.84 | 19.2 | 57 | 1534 |
| 68.15 | 18.4 | 57 | 1518 |
| 69.48 | 16.5 | 57 | 1506 |
| 70.79 | 17.6 | 57 | 1499 |
| 72.1 | 12.9 | 57 | 1504 |
| 73.42 | 13.7 | 57 | 1501 |
| 74.74 | 13.7 | 56 | 1488 |
| 76.06 | 12.2 | 55 | 1470 |
| 77.38 | 13.7 | 55 | 1456 |
| 78.7 | 15.3 | 54 | 1429 |
| 80.01 | 14.9 | 53 | 1412 |
| 81.33 | 12.5 | 53 | 1388 |
| 82.65 | 7.1 | 51 | 1329 |
| 83.96 | 0 | 49 | 1004 |
| 85.29 | 0 | 48 | 978 |
| 86.6 | 0 | 46 | 956 |
| 87.91 | 0 | 43 | 935 |
| 89.24 | 0 | 41 | 931 |
| 90.55 | 0 | 38 | 887 |
| 91.86 | 0 | 34 | 876 |
| 93.19 | 0 | 29 | 815 |
| 94.5 | 0 | 24 | 794 |
| 95.81 | 0 | 19 | 812 |
| 97.14 | 0 | 16 | 789 |
| 98.45 | 0 | 11 | 793 |
| 99.77 | 0 | 7 | 804 |
| 101.09 | 2 | 4 | 1024 |
| 102.41 | 8.2 | 4 | 1084 |
| 104.69 | 4.7 | 7 | 936 |
| 106.01 | 4.3 | 7 | 947 |
| 107.33 | 5.1 | 7 | 929 |
| 108.64 | 4.3 | 8 | 963 |
| 109.97 | 3.1 | 10 | 991 |
| 111.28 | 0.8 | 11 | 888 |
| 112.61 | 0 | 11 | 888 |
| 113.92 | 0 | 9 | 786 |
| 115.14 | 0 | 5 | 797 |
| 116.45 | 0 | 0 | 806 |
| 117.78 | 79.2 | 0 | 1764 |
| 119.09 | 100 | 11 | 2340 |
| 120.4 | 100 | 22 | 2915 |
| 121.73 | 100 | 32 | 2636 |
| 123.04 | 100 | 40 | 2802 |
| 124.35 | 100 | 46 | 2824 |
| 125.68 | 100 | 51 | 2633 |
| 126.99 | 100 | 55 | 2228 |
| 128.3 | 100 | 59 | 2319 |
| 129.63 | 100 | 62 | 2398 |
| 130.94 | 0 | 62 | 1749 |
| 132.26 | 0 | 60 | 1320 |
| 133.59 | 0 | 59 | 1270 |
| 134.9 | 0 | 56 | 1136 |
| 136.21 | 0 | 51 | 1059 |
| 137.54 | 0 | 49 | 977 |
| 138.85 | 0 | 46 | 940 |
| 140.16 | 0 | 41 | 915 |
| 141.49 | 0 | 35 | 862 |
| 142.8 | 0 | 28 | 793 |
| 144.12 | 0 | 21 | 803 |
| 145.44 | 0 | 15 | 794 |
| 146.76 | 0 | 10 | 794 |
| 148.07 | 0 | 0 | 800 |
| 149.4 | 0 | 0 | 804 |
| 150.71 | 92.2 | 1 | 1803 |
| 152.02 | 100 | 9 | 2393 |
| 153.34 | 100 | 22 | 2910 |
| 154.66 | 100 | 31 | 2630 |
| 155.99 | 100 | 39 | 2809 |
| 157.29 | 100 | 45 | 2926 |
| 158.62 | 100 | 50 | 2625 |
| 159.93 | 100 | 55 | 2192 |
| 161.24 | 100 | 59 | 2369 |
| 162.57 | 100 | 63 | 2376 |
| 163.88 | 0 | 62 | 1803 |
| 165.19 | 0 | 60 | 1262 |
| 166.52 | 0 | 60 | 1295 |
| 167.83 | 0 | 59 | 1261 |
| 169.15 | 0 | 58 | 1216 |
| 170.48 | 0 | 57 | 1169 |
| 171.79 | 0 | 55 | 1120 |
| 173.1 | 0 | 54 | 1075 |
| 174.43 | 0 | 53 | 1051 |
| 175.74 | 0 | 54 | 1054 |
| 177.05 | 0 | 53 | 1007 |
| 178.38 | 0 | 52 | 984 |
| 179.69 | 0 | 50 | 960 |
| 181.01 | 0 | 48 | 1211 |
| 182.33 | 9 | 46 | 1210 |
| 183.65 | 10.6 | 45 | 1142 |
| 184.96 | 5.1 | 42 | 1146 |
| 186.29 | 4.7 | 42 | 1178 |
| 187.6 | 3.1 | 43 | 1023 |
| 188.93 | 0 | 45 | 935 |
| 190.24 | 0 | 45 | 940 |
| 191.55 | 0 | 44 | 930 |
| 192.88 | 0 | 43 | 936 |
| 194.19 | 0 | 42 | 935 |
| 195.51 | 0 | 42 | 928 |
| 196.83 | 0 | 41 | 924 |
| 198.15 | 0 | 39 | 908 |
| 199.46 | 0 | 37 | 936 |
| 200.79 | 0 | 34 | 844 |
| 202.1 | 0 | 27 | 793 |
| 203.41 | 0 | 22 | 793 |
| 204.74 | 0 | 18 | 787 |
| 206.05 | 0 | 13 | 797 |
| 207.37 | 0 | 10 | 837 |
| 208.69 | 0 | 8 | 809 |
| 210.01 | 0 | 7 | 794 |

TABLE 3
test results with torque converter in accordance
with the present invention with trailer

| | Throttle Position | Vehicle Speed | Engine Speed |
|---|---|---|---|
| Time | Angle (%) | (MPH) | (RPM) |
| 0 | 0 | 0 | 800 |
| 1.31 | 100 | 0 | 1528 |
| 2.64 | 100 | 9 | 1886 |
| 3.95 | 100 | 17 | 2203 |
| 5.28 | 100 | 24 | 2648 |
| 6.59 | 100 | 29 | 2842 |
| 7.9 | 100 | 34 | 2512 |
| 9.2 | 100 | 38 | 2618 |
| 10.53 | 100 | 42 | 2731 |
| 11.84 | 100 | 45 | 2806 |
| 13.15 | 100 | 48 | 2892 |
| 14.48 | 100 | 51 | 3004 |
| 15.8 | 100 | 53 | 2616 |
| 17.11 | 100 | 55 | 2214 |
| 18.44 | 100 | 57 | 2170 |
| 19.75 | 100 | 58 | 2234 |
| 21.06 | 100 | 60 | 2301 |
| 22.39 | 72.2 | 62 | 2349 |
| 23.7 | 13.3 | 61 | 2378 |
| 25.01 | 0 | 60 | 2075 |
| 26.34 | 0 | 60 | 1318 |
| 283.13 | 0 | 0 | 803 |
| 284.46 | 100 | 1 | 1484 |
| 285.77 | 100 | 8 | 1895 |
| 287.08 | 100 | 17 | 2199 |
| 288.41 | 100 | 24 | 2637 |
| 289.72 | 100 | 29 | 2864 |
| 291.04 | 100 | 33 | 2515 |
| 292.36 | 100 | 37 | 2602 |
| 293.68 | 100 | 40 | 2716 |
| 294.99 | 100 | 43 | 2784 |
| 296.32 | 100 | 47 | 2862 |
| 297.63 | 100 | 50 | 2963 |
| 298.94 | 100 | 52 | 2996 |
| 300.27 | 100 | 55 | 2672 |
| 301.58 | 100 | 58 | 2179 |
| 302.89 | 100 | 60 | 2279 |
| 304.21 | 100 | 62 | 2353 |
| 305.52 | 100 | 63 | 2409 |
| 306.85 | 3.1 | 62 | 2351 |
| 400.38 | 0 | 0 | 801 |
| 401.71 | 100 | 0 | 1445 |
| 403.02 | 100 | 9 | 1938 |
| 404.33 | 100 | 20 | 2367 |
| 405.66 | 100 | 27 | 2764 |
| 406.97 | 100 | 33 | 2618 |
| 408.29 | 100 | 37 | 2620 |
| 409.62 | 100 | 42 | 2738 |
| 410.93 | 100 | 45 | 2816 |
| 412.24 | 100 | 48 | 2900 |
| 413.57 | 100 | 50 | 3019 |
| 414.88 | 100 | 52 | 2625 |
| 417.16 | 100 | 57 | 2179 |
| 418.48 | 100 | 60 | 2263 |
| 419.8 | 100 | 62 | 2362 |
| 421.12 | 0 | 62 | 2316 |

This torque converter assembly is a direct replacement. This custom torque converter does not require any specific instructions that exceed the normal skill in the art required for the use or installation of the original equipment torque converter that the end user would be removing because of poor performance and/or failure.

While the invention has been described with reference to certain exemplary embodiments thereof, those skilled in the art may make various modifications to the described embodiments of the invention without departing from the scope of the invention. The terms and descriptions used herein are set forth by way of illustration only and are not meant as limitations. In particular, although the present invention has been described by way of examples, a variety of compositions and methods would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A torque converter having an increase in capacity and an increase in efficiency.

2. The torque converter of claim 1, wherein the improved efficiency is provided through the multiplication stages of torque transfer and added multiplication effect to the lock up stage.

3. The torque converter of claim 2, wherein the increase in capacity is approximately 50%.

4. The torque converter of claim 3, wherein the increase in efficiency is approximately 10%.

5. The torque converter of claim 3, wherein the torque converter comprises a one piece billet cover that incorporates a thick steel ring three hundred and sixty degrees about the cover into which the flywheel is bolted.

6. The torque converter of claim 1, wherein the torque converter comprises one continual ring that evenly transfers the engine torque into the torque converter without clutch surface distortion.

7. The torque converter of claim 5, further comprising one continual ring that evenly transfers the engine torque into the torque converter without clutch surface distortion.

8. A method of modifying the performance of a motor vehicle comprising replacing the torque converter of the motor vehicle with the torque converter of claim 7.

9. The method of claim 8, wherein the motor vehicle comprises a Cummins 5.9 L diesel engine.

10. A torque converter for use with a diesel engine, comprising a one piece billet cover that incorporates a thick steel ring three hundred and sixty degrees about the cover into which the flywheel is bolted and one continual ring that evenly transfers the engine torque into the torque converter without clutch surface distortion.
